(19) United States
(12) Patent Application Publication
(10) Pub. No.: US 2017/0235720 A1
(43) Pub. Date: Aug. 17, 2017

(54) MULTILINGUAL TERM EXTRACTION FROM DIAGNOSTIC TEXT

(71) Applicant: GM Global Technology Operations LLC, Detroit, MI (US)

(72) Inventors: Prakash Mohan PERANANDAM, Bangalore (IN); Soumen DE, Bangalore (IN); Dnyanesh G. RAJPATHAK, Troy, MI (US)

(21) Appl. No.: 15/041,542

(22) Filed: Feb. 11, 2016

(51) Int. Cl. G06F 17/27; G06F 17/30; G01S 19/13; G01C 21/34; B60W 30/188; G06F 17/21; G06N 99/00

(52) U.S. Cl. CPC G06F 17/2785; G06F 17/2765; G06F 17/211; G06F 17/30705; G06N 99/005; G01C 21/34; B60W 30/188; G01S 19/13; B60W 2510/06

(57) ABSTRACT

A system and method of identifying relevant service terms within service records includes: receiving service terms included in one or more service records at computer processing equipment; classifying the service terms into a group of likely relevant service terms and a group of likely irrelevant service terms using the computer processing equipment; and identifying the relevant service terms from the group of likely relevant service terms and ignoring the likely irrelevant service terms using the computer processing equipment.

### TECHNICAL FIELD

The present invention relates to processing diagnostic text and, more particularly, to identify and extract relevant terms within the text.

### BACKGROUND

Occasionally, vehicle owners may experience a problem with their vehicles, and when they do the owners can seek help from a service technician who specializes in resolving those problems. As part of resolving the problem, the service technician may record the owner's description of the symptoms of the problem as well as a description of the vehicle parts addressed and actions taken during service as a service record. This service record can then be stored along with a vehicle description in a database containing a large number of these records for a fleet of vehicles. Service providers can review the records to identify particular terms, such as symptoms, parts, and actions, that occur with greater frequency.

Given that vehicles are serviced in many different countries, the records in the database may be written in different languages. To identify particular symptoms, parts, and actions within each record, the records can be reviewed by people who are fluent in a particular language and can manually identify symptom, part, and action words. But when a large number of records are reviewed by different people, the criteria used to identify symptoms, parts, and actions may not be universally applied. Also, the speed at which people review service records may not be adequate when processing a large number of records. It would be helpful to identify symptom, part, and action words without manually reviewing each service record.

### SUMMARY

According to an embodiment of the invention, there is provided a method of extracting terms from service records without regard to language. The method includes receiving service terms included in one or more service records at computer processing equipment; classifying the service terms into a group of likely relevant service terms and a group of likely irrelevant service terms using the computer processing equipment; and identifying the relevant service terms from the group of likely relevant service terms and ignoring the likely irrelevant service terms using the computer processing equipment.

According to another embodiment of the invention, there is provided a method of. The method includes receiving service terms included in one or more service records at computer processing equipment; classifying the contents of the service record(s) into a group of likely relevant terms and likely irrelevant terms; determining outlier index values for any remaining service terms; and including the service terms into groups of likely relevant terms and likely irrelevant terms based on the determined outlier index values.

According to yet another embodiment of the invention, there is provided a method of. The method includes executing a training phase, which comprises: associating service terms within a plurality of service records with a symptom, part, action, or irrelevant classification; determining a frequency of occurrence, a word position, or both for each service term; and storing the determined frequency of occurrence, word position, or both with the service term in a data structure. The method also includes executing an operational phase, which comprises receiving one or more additional service records; classifying the contents of the additional service record(s) into a group of likely relevant terms and likely irrelevant terms using the data structure; determining one or more semantic similarity index values for service terms; determining one or more outlier index values for service terms using a standard generic text document; and classifying service terms into groups of likely relevant terms or likely irrelevant terms based on the determined outlier index value(s).

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a flow chart of one aspect of an exemplary method of identifying relevant service terms within service records in a one-time training phase; and

FIG. 3 is a flow chart of another aspect of an exemplary method of identifying relevant service terms within service records in an operational phase.

### DETAILED DESCRIPTION OF THE ILLUSTRATED EMBODIMENTS

The system and method described below separates a group of service terms into categories of likely relevant service terms and likely irrelevant service terms and then further processes the category of likely relevant service terms to identify the relevant service terms in the category. Computer processing equipment including hardware and software can process service records that have been written in many different languages without translating these records or using humans having knowledge of the language review them. The computer processing equipment can undergo a one-time training phase that conditions it to identify service terms included in a plurality of training service records, which have been selected and used for training the equipment. The identified service terms can be stored in a data structure for an operational phase. After storing the identified service terms, the computer processing equipment enters the operational phase during which the computer equipment can receive service records and separate the content of those records into a group of likely relevant service terms and a group of likely irrelevant service terms based on a comparison of the service terms in the data structure as well as those in a standard generic text document. The group of likely relevant service terms can then be isolated so that the computer processing equipment can more accurately identify the relevant service terms within that group.

The operational phase includes a first level classification that classifies the service terms into a group of likely relevant terms and likely irrelevant terms using the data structure, determining one or more semantic similarity index values for remaining unclassified terms of the service records to form a unique list of terms (i.e., removing misspelled or abbreviated terms), and determining one or more outlier index values for the unique terms using the standard generic text document. The operation also includes a second level of classification that classifies the unique list of terms based on their outlier index values and adds to the group of likely relevant terms and likely irrelevant terms.

The service records can include content describing a wide variety of different topics. However, the following description is told in terms of service records that describe vehicle service, which can be provided by vehicle service centers, such as vehicle dealerships delivering vehicle maintenance and diagnostic services. Vehicle service can also be supplied by call centers that provide vehicle telematics service to the vehicle and as part of that service gather feedback regarding the symptoms, parts, and actions taken to adjust vehicle operation.

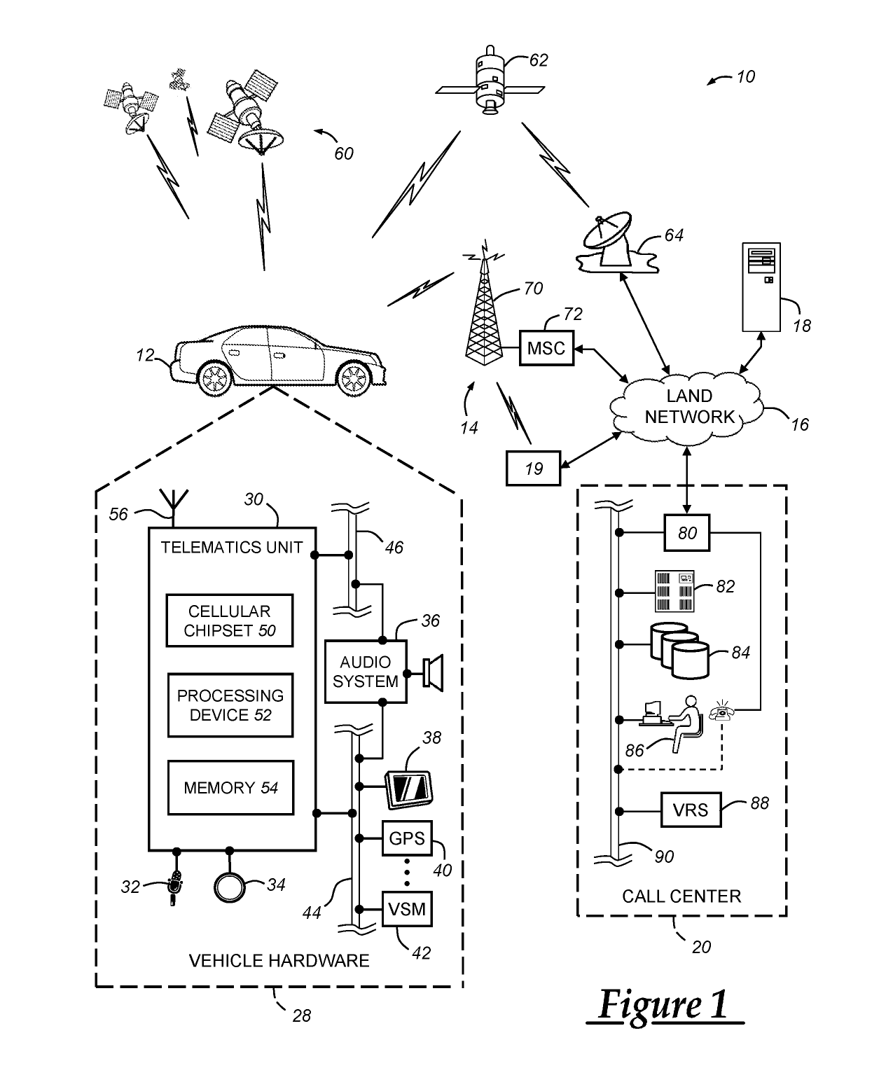

With reference to FIG. 1, there is shown an operating environment that comprises a mobile vehicle communications system 10 and that can be used as part of gathering service records for use with the method disclosed herein. Communications system 10 generally includes a vehicle 12, one or more wireless carrier systems 14, a land communications network 16, a computer 18, a vehicle service center 19, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, such as any of the IEEE 802.11 protocols, WiMAX, or Bluetooth. When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

The service center 19 is a location where vehicle owners bring the vehicle 12 for routine maintenance or resolution of vehicle trouble. There, vehicle service personnel can observe the vehicle and analyze vehicle trouble using a variety of tools, such as computer-based scan tools that obtain diagnostic trouble codes (DTCs) stored in the vehicle 12. As part of maintaining the vehicle 12 or analyzing vehicle trouble, vehicle technicians may memorialize the analysis in a service report, which can include the symptoms observed or reported, the parts affected, and the actions carried out by the vehicle technicians. The service records for vehicles serviced by the service center 19 can be stored at the center 19 or transmitted to a central facility, such as the call center 20, via the wireless carrier system 14 and/or the land network 16.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

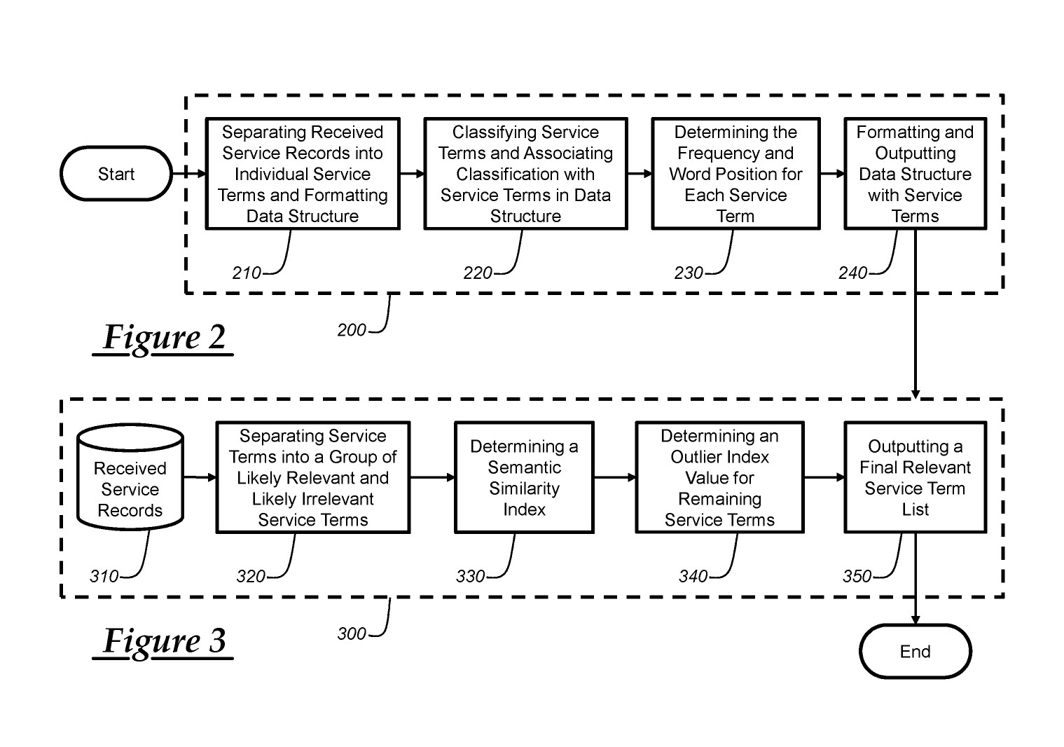

Turning now to FIG. 2, a method of identifying relevant service terms within service records is shown. The method comprises a one-time training phase (200) and an operational phase (300) that are shown with more detail in FIGS. 2 and 3, respectively. The computing hardware capable of carrying out the training phase (200) and testing phase (300) of service record processing could be implemented in a wide variety of locations. In one embodiment, the methods or phases described herein can be executed using computing hardware in the form of a personal computer (PC) having a 2.8 GHz Intel Core i7 processor operating Windows 7 64 bit operating system with 32 GB of RAM. The service records and the standard generic text document can be contained in a database that is stored in computer-readable memory devices, such as the PC hard drive, and accessed at the direction of the processor. However, it should be understood that this is just one implementation of the computer processing equipment, such as computer 18, and others are possible. For example, the computer 18 can include one or more PCs or server computers that can execute the methods disclosed herein.

The training phase (200) begins at step 210 by separating one or more received service records into individual service terms and formatting a data structure so that each service term is associated with a symptom, part, action, or irrelevant classification. Service records generally memorialize the problem(s) or symptoms vehicle owners report to service center personnel, such as vehicle mechanics, the part suspected of being affected by the problem, and the action taken to resolve the problem/symptom. Each visit to a service facility may result in a service record that can be identified by the date, location, and vehicle identity, such as a VIN, that provides distinguishing characteristics of the vehicle 12. These characteristics can include the vehicle manufacturer, model, color, mileage, equipment levels, and other similar information. Given that a vehicle manufacturer produces many vehicles that are currently being serviced in a way that generates service records in a wide range of areas, these service records can be generated in many different languages. In one implementation, the service center 19 can aggregate the service records it generates and transmit them to a central facility, such as the computer 18 or the call center 20.

The formatting can be implemented as a data structure recordable on non-volatile memory and include data cells for the service term, the classification, and other relevant data. Along with the service term and its classification, the data structure can also be set up to provide additional cells relating to each term or can also include a tag that identifies the vehicle 12 serviced, the time/date at which the service took place, options included on the vehicle, when the vehicle 12 was manufactured, or other similar information. The training phase 200 proceeds to step 220.

At step 220, the service terms can each be classified to be a symptom, a part, an action, or irrelevant and this classification can be associated with the service term in the data structure. A service record can include one or more symptoms, parts, and actions in addition to irrelevant terms that may be interlarded among them. The symptoms, parts, and actions are relevant service terms meant to be identified in a service record whereas other words can be considered irrelevant terms that can be tagged accordingly in the data structure. For instance, one example of a service record can read: OWNER COMPLAINS OF VIBRATING FRONT WHEELS AT HIGHER SPEEDS. SERVICE PERSONNEL REBALANCED AND REMOUNTED VIBRATING FRONT WHEELS. OWNER WILL RETURN IN AFTERNOON. This service record includes service terms in the form of symptoms, parts, and actions as well as irrelevant terms. The words VIBRATING and HIGHER SPEEDS can be classified as symptoms, the words FRONT WHEELS may be classified as parts, and the words REBALANCED and REMOUNTED can be classified as actions. The words OWNER COMPLAINS, SERVICE PERSONNEL, and WILL RETURN IN AFTERNOON can be classified as being irrelevant. In some implementations, these classifications can be made by human review during the training phase. After review, each of the service terms can be classified and the classification can be stored with each service term in the data structure. The training phase 200 proceeds to step 230.

At step 230, the frequency of occurrence and word position for each identified service term in step 220 can be determined and included with the service term in the data structure. Sometimes, the service terms occur in one service record or a plurality of service records more than one time and the frequency with which these terms appear can be helpful for analyzing service records and can shed light on the relative importance between terms. For example, using the service record above, the identified part word VIBRATING appears twice while the other service terms appear only once. The data structure can include a data value for each service term that indicates the number of times that service term has appeared, either in one service record or a large number of service records.

Apart from frequency, the word position of each identified service term can also be recorded. Starting with the first service term and counting to the last service term in the service record, each word or service term can be numerically identified relative to its position with other service terms. For example, using the service record example above, the service term VIBRATING can have a word position of 4 and 15 while WHEELS is numbered 6 and 17. When processing additional service records, the numbering can restart at 1. The training phase 200 proceeds to step 240.

At step 240, the data structure including the service term(s) and associated classification, frequency of occurrence, and/or word position can be formatted and output for use during the operational phase. Each service term can have its own data cell and a classification, a frequency value, and one or more word position values can be associated with that cell. With respect to word positions, a quantity of how many times that service term appears in a particular word position can also be stored. The data structure can be implemented in a variety of ways. In one implementation, the data structure can be a spreadsheet, such as one created using Microsoft Excel. The training phase 200 then ends.

Turning to FIG. 3, the operational phase (300) can begin at step 310 by receiving a plurality of service records and separating the service records into service terms that will later be classified into a group of likely relevant service terms and likely irrelevant service terms. After receiving the service records, the computer processing equipment can separate the contents into discrete service terms. In some languages, this service record content can be separated based on spaces between words. The operational phase 300 proceeds to step 320.

At step 320, the received plurality of service terms from step 310 can be separated into a group of likely relevant service terms and a group of likely irrelevant service terms. The computer can use the data included in the data structure generated during the training phase 200 to then identify relevant service terms in newly-received service records. By comparing the service terms found in the data structure with the service terms of the received service records, the computer processing equipment can identify service terms that have been categorized in the data structure as a symptom, a part, or an action and then include them in the likely relevant group of service terms. Service terms in the received service records that have been determined to correspond to irrelevant terms in the data structure can be categorized in the likely irrelevant service terms group. The operational phase 300 proceeds to step 330.

At step 330, a semantic similarity index can be determined for service terms included in a plurality of service records. In many service records, a service term may be recorded using abbreviations or short-form notation. To ensure that these abbreviations are included with the likely relevant service terms group, the computer processing equipment can determine how closely a service term found in a service record resembles service terms included in the data structure. For example, the service term BATTERY can be classified a part but the service term BATT should be classified that way too. To ensure that the service term BATT is viewed similarly as BATTERY, a semantic similarity calculation can be performed. In one implementation, a Jaccard Distance can be calculated between the terms. If this distance is greater than a threshold, for example 0.5, the terms can be determined to be semantically similar. The Jaccard Distance calculation is represented below.

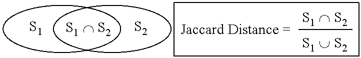

Values greater than 0.5 can be viewed as indicating that it is more likely than not that the two service terms are related or closer to each other. The operational phase 300 proceeds to step 340.

At step 340, an outlier index value can be determined for each of the remaining uncategorized service terms of new service records by comparing those terms to the Standard Generic Text Document (SGTD). The values can be used to classify the uncategorized service terms as being relevant or irrelevant based on a determined threshold. The SGTD can be helpful to augment the content provided by the training service records, which may only include a relatively limited number of relevant and irrelevant terms for comparison. During the operational phase, the incoming service records may include both relevant and irrelevant terms that are outside of what was included in the training service records. Thus, the SGTD may be selected to include a larger number of irrelevant terms. The SGTD can be a text file that includes text representing a technical article or a non-technical article (such as a newspaper story) that includes a significant number of terms that were not included in the training service records. Often, the SGTD may include more irrelevant words like “is,” “was,” “there,” or “where” that may be used to identify irrelevant terms. When the terms are determined to be closer to the SGTD using the outlier index value, those terms can be identified as likely irrelevant due to the higher propensity that irrelevant words are found in the SGTD. And when the terms are determined to be further from the SGTD using the outlier index value, they can be identified as likely relevant.

The calculation to determine the outlier index value can determine whether or not to exclude any service terms from the group of likely relevant service terms. And the outlier index value can be determined in a variety of ways. In a simpler implementations, the outlier index value can be determined using the formula:

$$( {W}_{i} ) = \frac{{N}_{GL} ( {W}_{i} ) ⋆ {f}_{SL} ( {W}_{i} )}{( 1 + {f}_{GL} ( {W}_{i} ) ) ⋆ {N}_{SL} ( {W}_{i} )}$$

W represents the outlier index value, f_{SL} represents the frequency of a service term in the received service records, f_{GL} represents the frequency of the service term in the SGTD, N_{SL} indicates the total number of terms in the received service records, and N_{GL} indicates the total number of terms in the SGTD.

After determining the outlier index value for each service term in the received service records, the outlier index values can be compared to a threshold to determine whether or not the service term should be part of the likely relevant service terms group or not. In one implementation, the threshold for the outlier index values can be set to 0.40 such that values above this threshold can be deemed to belong in the group of likely relevant service terms whereas values equal to or below this threshold belong in the group of likely irrelevant service terms. The operational phase 300 proceeds to step 350.

At step 350, a final relevant service term list can be output. The service terms remaining after inclusion using the semantic similarity index and exclusion by the outlier index value can then be formalized at the relevant service terms. The formalization process can include identifying the service terms and the frequency with which each of the relevant service terms appears. In one implementation, standard tf (term frequency) or tf-idf (term frequency-inverse document frequency) values for each likely relevant service terms can be calculated. The threshold value can be set to 0.4 and the terms with equal or higher tf/tf-idf value may be included in the final list extracted service terms. The operational phase 300 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of identifying relevant service terms within multilingual service records, comprising the steps of:
(a) electronically receiving at a central facility, service center, or both, multilingual service records;
(b) separating content from the multilingual service records into service terms using computer processing equipment at the central facility, service center, or both;
(c) classifying the service terms into a group of likely relevant service terms and a group of likely irrelevant service terms based on a comparison of the service terms with a trained database using the computer processing equipment; and
(d) identifying the relevant service terms from the group of likely relevant service terms and ignoring the likely irrelevant service terms using the computer processing equipment.

2. The method of claim 1, wherein the service records include service terms describing vehicle service.

3. The method of claim 1, further comprising the step of classifying the service terms as a symptom, a part, or an action.

4. The method of claim 3, further comprising the step of classifying at least one service term as irrelevant.

5. The method of claim 1, wherein step (c) further comprises determining an outlier index value.

6. The method of claim 1, wherein step (c) further comprises determining a semantic similarity index value.

7. A method of identifying relevant service terms within multilingual service records, comprising the steps of:
(a) electronically receiving at a central facility, service center, or both, multilingual service records;
(b) separating content from the multilingual service records into service terms using computer processing equipment at the central facility, service center, or both;
(c) classifying the contents of the service record(s) into a group of likely relevant terms and likely irrelevant terms based on a comparison of the service terms with a trained database;
(d) determining outlier index values for any remaining service terms; and
(e) including the service terms into groups of likely relevant terms and likely irrelevant terms based on the determined outlier index values.

8. The method of claim 7, wherein the service terms describe vehicle service.

9. The method of claim 7, further comprising the step of classifying the service terms as a symptom, a part, or an action.

10. The method of claim 9, further comprising the step of classifying at least one service term as irrelevant.

11. The method of claim 9, further comprising the step of determining a semantic similarity index value.

12. A method of identifying relevant service terms within service records, comprising the steps of:
(a) executing a training phase, which comprises:
(a1) associating service terms within a plurality of service records with a symptom, part, action, or irrelevant classification;
(a2) determining a frequency of occurrence, a word position, or both for each service term;
(a3) storing the determined frequency of occurrence, word position, or both with the service term in a data structure;
(b) executing an operational phase, which comprises:
(b1) receiving one or more additional service records;
(b2) classifying contents of the additional service record(s) into a group of likely relevant terms and likely irrelevant terms based on a comparison of the service terms with the data structure;
(b3) determining one or more semantic similarity index values for service terms in the additional service record(s);
(b4) determining one or more outlier index values for service terms in the additional service record(s) using a standard generic text document; and
(b5) classifying service terms in the additional service record(s) into groups of likely relevant terms or likely irrelevant terms based on the determined outlier index value(s).

13. The method of claim 13, wherein the service terms describe vehicle service.

14. The method of claim 1, further including formatting a data structure during a training phase to generate the trained database.
